(19) United States
(12) Patent Application Publication
(10) Pub. No.: US 2006/0082563 A1
(43) Pub. Date: Apr. 20, 2006

(54) Active matrix drive display elements

(76) Inventors: Toshihiro Nishioka, Chiba (JP); Akihiro Nonaka, Chiba (JP); Sadao Takano, Chiba (JP)

Correspondence Address: QUARLES & BRADY LLP, 411 E. WISCONSIN AVENUE, SUITE 2040, MILWAUKEE, WI, 53202-4497, US

(21) Appl. No.: 11/243,402

(22) Filed: Oct. 4, 2005

(30) Foreign Application Priority Data
Oct. 4, 2004 (JP) 2004-291785

(51) Int. Cl. G09G 5/00

(52) U.S. Cl. 345/204

(57) ABSTRACT

A high-intensity, uniformed luminescence, high-density active matrix fluorescent display tube having plural pixels, plural scanning lines and plural signal lines is disclosed. The display element includes a logic circuit, a holding unit, an AND circuit, a pre-driver circuit, and a pixel driver. The logic circuit is composed of a row address selection circuit for each pixel, input data and a logic control circuit. The holding unit drives an anode electrode disposed for each pixel. The AND circuit performs logical product on a signal held in the holding unit and a blanking reverse signal from an input data signal line. The pre-driver circuit drives the output transistor in the previous stage. The pixel driver is conformed of the driver output circuit connected to the pre-driver circuit. The pre-driver circuit is formed of an enhancement-mode P-channel field-effect transistor and a depletion-mode P-channel field-effect transistor.

### CROSS REFERENCE TO RELATED APPLICATIONS

This application claims the priority benefit of Japanese Patent Application No. 2004-291785 filed on Oct. 4, 2004.

### STATEMENT REGARDING FEDERALLY SPONSORED RESERACH

Not Applicable.

### BACKGROUND OF THE INVENTION

The present invention relates to active matrix drive display elements having a semiconductor device including plural anodes to be respectively driven and formed in a matrix form formed on the inner surface of a vacuum envelope. More particularly, the present invention relates to fluorescent display tubes, electro-luminescent displays (ELDs), and field emission displays (FEDs), enabling high definition and high intensity.

Presently, liquid crystal displays, plasma displays, ELDs, fluorescent display tubes, FRDs, and the like are being practically used as flat panel displays. Among them, the fluorescent display tubes and FEDs belong to self-luminous type displays. These displays are being developed for use in the next generation television sets, instead of conventional CRTs, because they enable high resolution.

Particularly, the active matrix drive fluorescent displays, which can provide high brightness or intensity, have been expected for use in head-up display elements.

However, when such a display is driven using the single matrix, the duty ratio becomes small with the increasing resolution of display, thus resulting in insufficient brightness. Further, there is caused degradation of luminous elements or degradation of luminous substances (such as fluorescent substances), if the current is increased to obtain sufficient brightness.

In the fluorescent display tube, a desired pattern is displayed by impinging electrons emitted from cathodes in a vacuum envelope (housing) having at least a transparent surface on the side thereof, a fluorescent substance coated on the corresponding anode to emit light. Of such fluorescent display tubes, there is an active matrix fluorescent display tube that includes a luminous display surface obtained by a semiconductor chip mounted on an insulating substrate. On the semiconductor chip, a luminous display section, in which plural anodes, each coated with the fluorescent substance, are arranged in a matrix form, and a drive circuit for controlling the luminescence of the luminous display section are integrally fabricated.

The drive circuit constituting the active matrix drive fluorescent display tube is disclosed, for example, in Japanese Patent Publication No. 56-24993. In this reference, a fluorescent substance is coated on the source electrodes of field-effect transistors (FETs) integrated on a single-crystal substrate to form display dots. The displaying operation is realized when the fluorescent substance glows with electrons emitted from a cathode electrode. The brightness is controlled by the potential of the corresponding gate electrode or drain electrode.

The Japanese patent Publication No. 6-71202, discloses a liquid crystal drive circuit including, as a unit circuit, a totem-pole type MOS transistor circuit. That MOS transistor circuit is formed of four N-channel metal oxide semiconductor (MOS) transistors, which convert a pair of input signals, having a normal phase and a reverse phase, for high speed and low power consumption, into a pair of output signals, having a normal phase and a reverse phase, with a large current drive capability.

As an active matrix drive display element of the high-speed and low power consumption, CMOS transistors, are generally used. Each CMOS transistor is formed of a P-channel MOS transistor and an N-channel MOS transistor, are generally used.

The Japanese Patent Laid-open Publication No. 2002-244588 discloses an image display device in a luminous maintenance-type display including pixel selection transistors, pixel current control transistors, and signal voltage holding capacitors. In the display, an adjacent scanning line acting as a voltage supply line eliminates the area occupied by the voltage supply lines. In the image display device, a decrease in the aperture ratio or pixel electrode area can be minimized to obtain sufficient display brightness. Moreover, in the image display device disclosed, the pixel selection transistor has the gate connected to one scanning line, the source connected to the signal line, and the drain connected to one electrode of a capacitor and the gate of the pixel current control transistor. The pixel current control transistor has the drain connected to the pixel electrode and the source connected to the other electrode of the capacitor and the other scanning line.

In the active matrix-type fluorescent display device, a luminous display side is constructed with a semiconductor chip. A luminous display section having anode electrodes, each on which a fluorescent substance is coated, arranged in a matrix form and a drive circuit which controls the luminescence of the luminous display section are integrally formed on the semiconductor chip. Accordingly, the manufacturing method, such as photolithography or etching, in the semiconductor integrated circuit manufacturing technique can be utilized to form easily fine wiring conductors or anode electrodes on a silicon chip. That is, the packing density of dots, each which is formed of anode electrodes, can be increased. By coating fluorescent substances on the anode electrodes, using the photolithography or printing technique, a higher definition dot matrix configuration can be realized.

Further, in the luminous display section of the active matrix drive fluorescent display tube, a fluorescent substance is coated on each of anodes connected to the drive circuit, which is formed on the silicon film overlying a glass substrate. The anode, on which a fluorescent substance is coated, is connected to the drive circuit via a through hole formed in the insulating film over the silicon film. This technique includes expanding the anode by connecting the drive circuit to the anode via the through hole formed in the insulating layer on the upper surface of the silicon film, so that the pixels can be arranged at 0.31 mm pitches. (For example, referred to Japanese Patent Laid-open Publications No. 2002-8571 and No. 2002-215098).

The Japanese Patent Laid-open Publication No. 11-329310 discloses the technique of equalizing the light emission of the luminous display section. In this technique, an auxiliary electrode acting as a flat grid surrounding respective anode electrodes is disposed on the surface of the anode electrode forming surface of the anode substrate and the auxiliary electrode is grounded or connected to the positive voltage source. The Japanese Patent Laid-open Publication No. 2004-87404 discloses the technique of equalizing the light emission of the luminous display section. In this technique, a fluorescent display device includes a grid electrode disposed between an anode electrode and a filament-shaped cathode and a vacuum envelope containing the anode electrode, the filament-like cathode, and the grid electrode and having at least one transparent side. An auxiliary electrode surrounds each of the anode electrodes on the anode electrode forming surface of the anode substrate. The auxiliary electrode is grounded or connected to the positive voltage source.

As described above, the conventional active matrix fluorescent display device enables static display because it uses the anode substrate, on which the luminous display section having anodes, coated with a fluorescent substance, arranged in a matrix form, and a control circuit for controlling light emission of the luminous display section, are integrally formed. For that reason, the conventional device has an excellent effect of realizing a high intensity of 3000 to 4000 cd/cm² with an anode voltage of +15 volts and enabling a high resolution dot-matrix configuration because of the high pixel density.

Inasmuch as a conventional fluorescent display tube can provide high intensity display and high pixel density, the excellent effect of realizing a high-resolution dot matrix configuration is fully utilized. For this reason, some head up displays use the higher-intensity active fluorescent display tube. That is, when the filament bias voltage is negative and the grid voltage and the anode voltage are 24 volts, respectively, the intensity of the VFD is 8400 cd/m². However, when the filament bias voltage is negative, the non-display section glows with a brightness of 300 cd/m² because there is a potential difference of the grid and the anode with respect to the filament even in non display mode (for example, refer to Japanese Patent Laid-open Publication No. 11-174989).

However, in the case of the active matrix driving, the problem is that the number of transistors and the number of wiring conductors are increased. In the fluorescent display tubes, FEDs or ELDs according to the conventional active matrix drive operation, a constant voltage line and a voltage supply line are required in addition to the scanning line and the signal line. Moreover, current drive transistors are required in addition to the pixel selection transistors and the signal voltage holding capacitors. Therefore, in the case of the active matrix driving, the problem is that increasing the number of transistors and the number of wiring conductors causes decreasing the pixel electrode area or the aperture ratio.

Particularly, the constant voltage line for flowing current is required to decrease sufficiently its resistance and hence occupies largely the pixel area. For example, when the pixel size is 100 μm×300 μm, the constant voltage line occupies a large ratio (for example, 10%) of the pixel area, while the wiring width is 10 μm and the wiring length is 300 μm. As a result, in the case of organic ELDs, the problem is that the aperture ratio decreases, thus dimming the display.

Further, in the conventional active matrix drive fluorescent display tube, the pitch distance between anodes in the luminous display section is a critical value of 310 μm. An auxiliary electrode surrounding each anode is disposed to prevent uneven light emission in the periphery and-degradation in the display quality. This arrangement requires an anode pitch distance of 70 μm (being the sum of the auxiliary electrode of 32 μm and the spacing between the auxiliary electrode and the anode). Thus, one side of the display pixel becomes 240 μm. The luminous surface occupation ratio with respect to the display area has a critical value of 59%. The problem is that the pixel size and the luminous area occupation ratio have limitations and fine displaying becomes difficult.

To solve the above-mentioned problems and miniaturize the anodes in the active matrix drive fluorescent display tube, the present inventor studied on the miniaturization of anodes, narrowing of the pitch of the fluorescent substances formed on the anode surface, and equalization of light emission.

In the case of the conventional N-channel MOSFET circuit, the IC chip area becomes large because of an increased number of power source lines in the whole IC chip, two power source lines (including a low-voltage power source line and a high-voltage power source line) required in the display pixel portion, and an increased number of high withstand voltage transistors.

In the case of the conventional CMOSFET circuit, two power source lines for low voltage and high voltage are required and the fabrication of two transistor elements (including a P-channel MOS transistor and an N-channel MOS transistor) leads to an increased number of photomasks. Hence, the problem is that the wafer cost does not reduce.

The circuit configuration of the active matrix drive device, which includes active matrix drive elements, formed of N-channel MOS transistors, will be described below by referring to FIG. 5.

The active matrix drive device 50 shows a driver circuit for one pixel. The active matrix drive device 50 consists of the display pixel row selection circuit 51 and the logical control circuit 52, the holding unit 53 and the drive circuit unit 59, for driving the anode electrode disposed for each display pixel, and the driver output circuit 60 for the display pixel unit 61, the address signal line 55, the data signal line 56, the power source 63, and the filament 62. The depletion-mode MOSFET 58 turns the gate (in the final output stage) to a high level. The depletion-mode MOSFET 58 may be replaced with a high resistance element.

The input signal is a row address selection signal, a logic control signal, or a display data signal. The decoder selects only one row address signal line 55 with the row address signal. The display data is input every column.

The holding unit 53 holds data to respective pixels arranged in a matrix form according to the row address signal and the data signal. This corresponds to data for one row. The row address signals are sequentially incremented. This step is repeated until data is written into all rows.

A combination of the driver output circuit 58, 59 and the driver output circuit 60 of the display pixel section 61 receives a logical product of the holding data and the blanking signal and thus outputs the display data.

The driver circuit is formed of an enhancement-mode N-channel MOS transistor 59 and a depletion-mode N-channel MOS transistor 58. The driver circuit in the final stage is formed of an N-channel MOS transistor 60. Each of the three N-channel MOS transistors 58, 59, and 60 is formed of a high withstand voltage N-channel MOS transistor.

The N-channel MOS transistor used for the driver circuit must be set to GND or OPEN, in an OFF display mode. Because of this reason, the voltage of the output of the N-channel MOS transistor is varied between the ground (GND) voltage and a high voltage (VH). In addition to the driver circuit in the final stage, the driver circuit 59 requires a high withstand voltage MOS transistor. As a result, the circuit formed of N-channel MOS transistors has limitations to decrease the area of the pixel portion. That is, the circuit consumes a large volume of current, requires a high-voltage power source in addition to a low-voltage power source, requires two power sources for each pixel, and requires three high withstand voltage transistors.

In order to attempt narrowing the fluorescent material dot pitch and equalizing the light emission, the present inventor fabricated a fluorescent display tube by improving the conventional active matrix drive fluorescent display tube in such a manner that the pitch between luminous portions formed of a large number of dot-shaped pixels as an anode on which a ZnO:Zn fluorescent material layer emitting cyanic color is coated, is set to be 310 μm and an auxiliary electrode having width of 32 μm is formed around each anode. Thus, 70 μm corresponding to the sum of the auxiliary electrode width and the anode pitch is secured for the space between anodes. The fluorescent display tube further includes an active matrix substrate on which square display pixels having 240 μm on each side are formed and a grid disposed above the anode.

A heat sink is mounted on the back surface of the anode substrate in the active matrix drive fluorescent display tube. The display state of complete product was ascertained, with 21.5 volts applied to the grid and with 60 volts applied to the anode. As a result, 20000 cd/m² was obtained, but the grid deformed and contacted with the filament. A reliable active matrix drive fluorescent display tube could not be obtained.

In order to obtain a reliable active matrix drive fluorescent display tube with a high intensity of 20000 cd/m², it was found that the mesh grid must be removed to prevent the thermal deformation thereof and the flat grid must be removed to improve the fluorescent substance occupation ratio.

However, merely eliminating the mesh grid and the flat grid may result in defects in a character which was a problem in the conventional art.

It was assumed and studied that, by arranging filaments at a small pitch, the defective character, by which pixels between filaments glow insufficiently, may be improved.

The following factors decreasing the defects in the character were guessed to find solutions.

Firstly, pixels, each on which a fluorescent substance is coated, disposed immediately beneath a filament, and pixels, on which a fluorescent substance is coated, disposed below the space between filaments, glowed uniformly. In this case, the distance between a filament and an anode is, for example, 1 mm. The distance between filaments is, for example, 1.5 mm. Thus, the distance between the anode at the middle of the space between suspended filaments and a filament is set to be longer than the distance between filaments. By narrowing the spacing between filaments, the velocity component V of thermal electrons emitted radially from a filament (the velocity component in parallel to the pixel plane of the thermal electrons emitted radially from a filament) is not notably decreased. Accordingly, that configuration can minimize the effect of a wafer or pixels, not driven, adjacent to the wafer, which is set to the same as the filament potential.

Secondly, the anode at the middle of the space between filaments receives sufficiently thermal electrons from a filament. Even when the adjacent anode is in a non-light state, sufficient electrons are supplied. Thus, the character missing caused by a pixel, on which a fluorescent substance disposed below the space between filaments is coated, can be reduced, so that the display quality is equalized.

### SUMMARY OF THE INVENTION

The present invention is made based on the above-mentioned knowledge.

An object of the present invention is to provide an image display device which can obtain sufficient display brightness, with a decrease in aperture ratio and a decrease in pixel electrode area, suppressed at minimum, in active matrix drive display devices such as fluorescent display tube, organic ELDs, or FEDs.

Further, the present invention is to provide a high-intensity active matrix drive fluorescent display tube including an anode substrate on which a luminous display section arranged in a matrix form and a driver circuit for selectively controlling anode electrodes and controlling light emission of the luminous display section are integrally formed on a substrate. The luminous display section is formed of plural anodes on which a fluorescent substance is coated. The spacing of anodes is narrowed. The high-intensity active matrix drive fluorescent display tube can deal with an active matrix drive fluorescent display tubes, multi-color active matrix drive fluorescent display tubes, head-up displays, each of which includes a fine anode and a luminous display section with uniform light emission.

The present invention is made to solve the above-mentioned problems. An active matrix drive display element, including plural pixels, plural scanning lines, and plural signal lines, comprises a pixel driver; the pixel driver including a logic circuit formed of a row address selection circuit and a logic control circuit; a holding unit disposed for each pixel; an AND circuit for performing logical product on a signal held in the holding unit and a blanking reverse signal from an input data signal line; a pre-driver circuit formed of an enhancement-mode P-channel field-effect transistor and a depletion-mode P-channel field-effect transistor; and an output driver circuit connected to the pre-driver circuit.

According to the present invention, the pre-driver circuit comprises an enhancement-mode P-channel field-effect transistor and a high resistance element.

Another aspect of the present invention, an active matrix drive display element, including plural pixels, plural scanning lines, and plural signal lines, comprises a logic circuit formed of a row address for each display pixel and a logic control circuit; a holding unit and a driver circuit, for driving an anode electrode disposed for each display pixel; and a driver output circuit in a display pixel unit. An input signal is formed of a row address selection signal, a logic control signal, and display data; and a decoder selects a row address signal for one row only; and display data is input for each column; and display data for pixels arranged in a matrix form by an AND circuit, which performs logical product on the row address signal and the data signal line, correspond to data for one row; and the row address signal is sequentially incremented repeatedly until data are written for all rows. The AND circuit, which performs logical product on holding data and a blanking signal, outputs data as display data to the driver circuit in the final stage via the driver circuit.

According to the present invention, because the driver circuit can be miniaturized, the size of a pixel on which a fluorescent substance is coated can be miniaturized. Because the memory section and the output driver circuit are disposed under pixels, an erroneous operation of the IC due to incoming light or electron rays can be prevented.

Miniaturization of each pixel allows the gap between dots to be decreased. According to the high-precision active matrix drive fluorescent display tube, the display quality is improved. The increased plane brightness (or intensity) allows the high brightness and the number of pixels of the display section projected by a half mirror (or a combiner) to be easily increased.

Pixels, each configured of two color luminous anodes, can realize the high intensity of the high-precision multiple-color luminous active matrix drive fluorescent display tube. Moreover, pixels, each configured of three color luminous anodes, can realize the high intensity of the high-precision full-color luminous active matrix drive fluorescent display tube.

### BRIEF DESCRIPTION OF THE DRAWINGS

This and other objects, features, and advantages of the present invention will become more apparent upon reading of the following detailed description and drawings, in which:

FIG. 1 is a schematic diagram illustrating a P-channel MOS FET circuit, according to the present invention;

FIG. 2 is a diagram illustrating a configuration in one pixel;

FIG. 3 is a diagram illustrating a multiple drive circuit according to the present invention;

FIG. 4 is a circuit diagram illustrating a fluorescent display tube system according to the present invention; and

FIG. 5 is a schematic diagram illustrating a conventional N-channel MOS FET circuit.

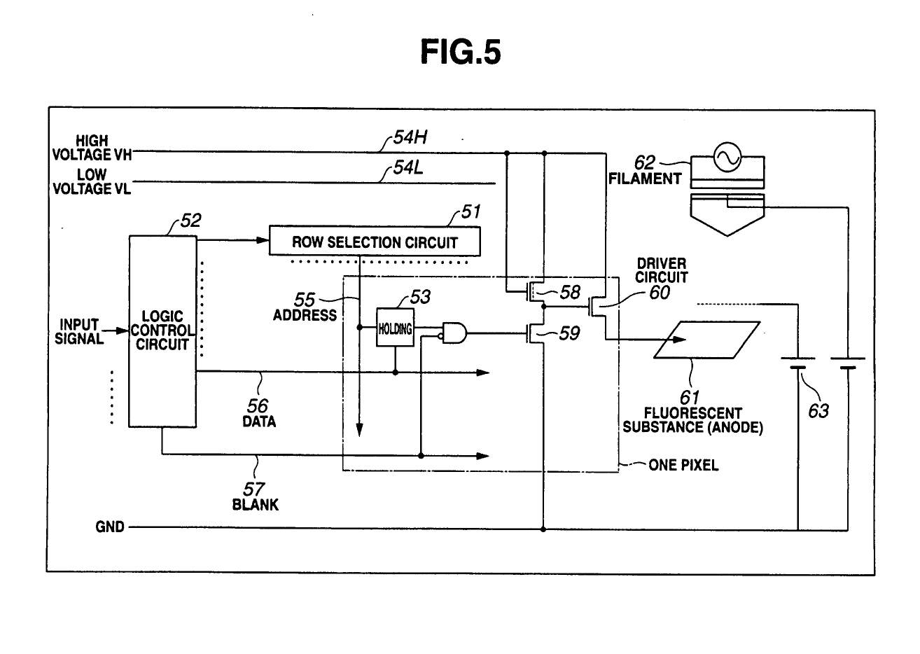

### DESCRIPTION OF THE EMBODIMENTS

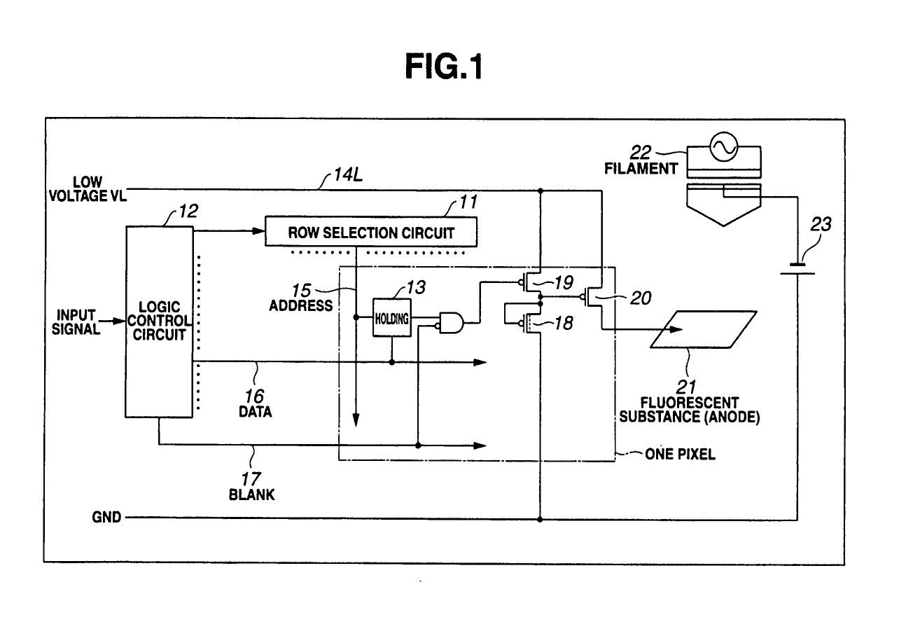

An active matrix drive device including fine anodes constructed with P-channel MOS transistors according to an embodiment of the present invention will be described below by referring to FIG. 1.

Referring to FIG. 1, an active matrix drive device comprises a logic circuit formed of a row address and logical control circuit for a display pixel, a holding unit and a drive circuit, for driving an anode electrode for each display pixel, and a driver output circuit for a display pixel section.

The active matrix driver device 10 includes a drive circuit formed of a row selection circuit 11 and a logic control circuit for a display pixel, a holding unit 13 and a drive circuit 19, for driving an anode electrode formed for each display pixel, and a driver output circuit 20 for a display pixel section 21, an address signal line 15, a data signal line 16, a power source 23, and filaments 22. This drive circuit 10 is shown for one pixel. The depletion-mode MOSFET 18 turns the gate in the final output stage into a low level and may be replaced with a high resistance element.

The input signal includes a row address selection signal, a logic control signal, and a display data signal. The selector selects only the address signal line 15 of one row, in response to the row address signal. The display data is input for each row.

In response to the row address signal and the data signal, the holding unit 13 holds data for each of pixels arranged in a matrix form. The data corresponds to data per row. Sequentially incrementing the row address signal is repeated until data for all rows are written.

The drive circuits 18 and 19 and the driver output circuit 10 for the display pixel 21 receive the data output in response to a logical product of the holding data and the blanking signal and then output display data.

The drive circuit is formed of an enhancement-mode P-channel MOS transistor 19 and a depletion-mode P-channel MOS transistor 18. The final stage driver circuit is formed of a P-channel MOS transistor 20. Only the P-channel MOS transistor 18 is a high withstand voltage N-channel MOS transistor.

The input signal includes a row address selection signal, a logic control signal, and a display data signal. The row address signal is selected for only the single line by means of the selector. The display data is input for each column.

The AND circuit, connected to the row address signal line and the data signal line, holds data for each of pixels arranged in a matrix form. That corresponds to data for one row. The row address signal is sequentially incremented and this operation is repeated until data for all rows are written. The final stage driver circuit receives data output from the AND circuit, coupled to the holding data and the blanking signal, via the drive circuit and outputs display data. The drive circuit is formed of only an enhancement-mode P-channel MOS transistor and a depletion-mode P-channel MOS transistor. The final stage driver is formed of a P-channel MOS transistor.

Accordingly, in the anode drive operation, the signal level voltage is applied to the anode electrode overlapped with a filament center tapped voltage, which permits the signal output from the drive circuit to be at a low-level voltage, and eliminates high withstand voltage transistors except the final stage transistor.

The active matrix drive device of the present invention can be constructed only with P-channel MOS transistors, each display pixel portion requires only a low voltage power source and GND. Accordingly, a single high withstand voltage transistor with a large design rule is required for each pixel so that the current consumption can be suppressed to a small value. Further, the pixel size can be reduced because two power source lines, including a low voltage and GND, are enough for the system. Accordingly, the holding circuit, the drive circuit, and the driver circuit can be arranged under the anodes forming pixels in the driver output section. Furthermore, the pixels can be arranged in a narrow pitch so that high definition display can be realized.

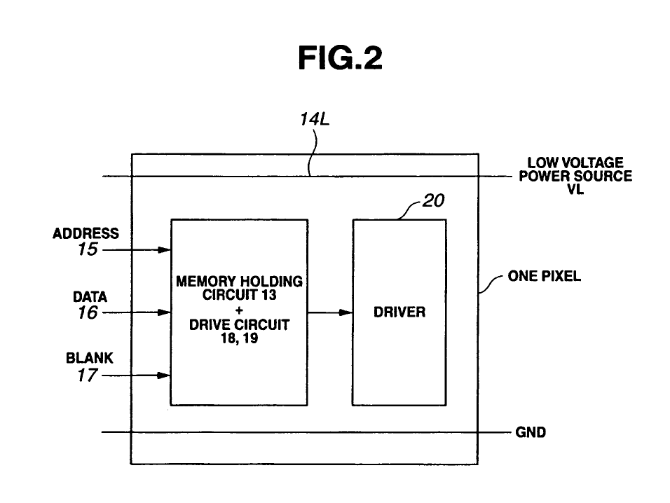

A configuration of one pixel is shown in FIG. 2.

The pixel includes a memory holding circuit, a driver circuit, and a driver. The pixel portion on which a fluorescent substance is coated has two Al layers. The above-mentioned circuits are arranged beneath the two Al-layer pattern. Because each circuit has the configuration that shields incoming light or electron rays, the reliability of the IC increases.

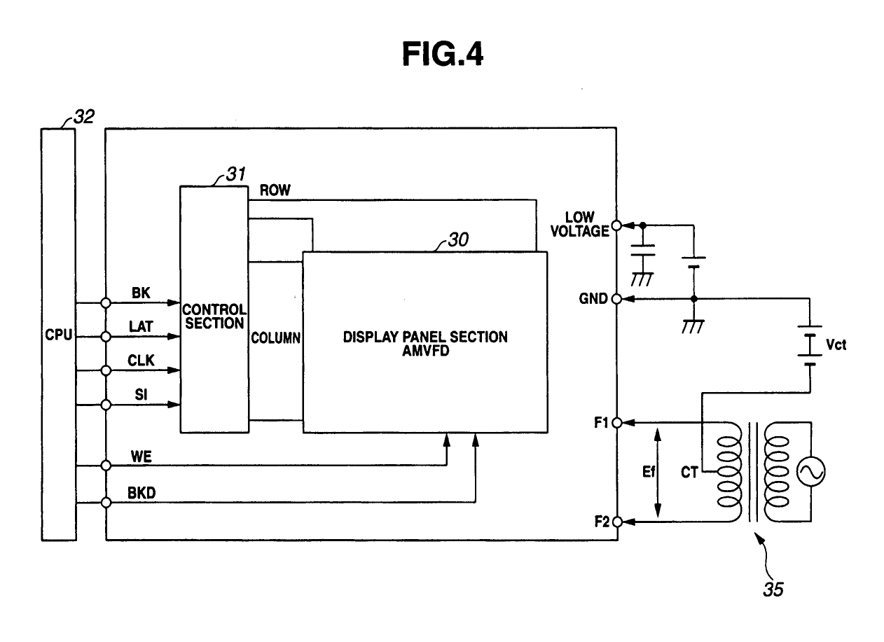

FIG. 4 shows a fluorescent display tube system embodying an active matrix drive display element. The fluorescent display tube system includes a display panel 30 and a controller (control IC) 31 for driving the display panel 30. The control IC 31 uses a serial to parallel driver for a CIG (chip in glass). A controller IC having a memory function may be used as the control IC 31.

This system receives a serial data signal (SI) from the CPU 32 in synchronous with the CLK signal. The LAT signal is a signal for writing data into the controller IC 31. The BK signal is a signal from the controller, for determining the output width. Both the WE signal and the BKD signal are inputted directly to the display panel. The WE signal is a data writing control signal. The BKD signal is a signal for adjusting the brightness of the display section 30.

In the circuit configuration, only the low voltage power source is used as the IC drive power source. The circuit configuration further requires a power source (Vct) for the center tap of the filament 35, as additional power source. Because the display panel circuit is constructed of P-channel transistors only, the driver can drive advantageously with a low voltage.

In the active matrix drive display element equipped in the fluorescent display tube system of the present invention, the luminous portions are made of a large number of dot-shaped pixels arranged in a matrix form at intervals of 20 μm. In each luminous portion, a fluorescent substance layer of ZnO:Zn emitting a cyanic color is coated on an electrode of a square aluminum (Al) thin film having one side of 226 μm.

Each electrode formed of a square Al thin film having one side of 226 μm is connected to the drain of the output driver of each active matrix drive element via the through hole formed in an insulating layer overlying a silicon wafer. The area occupation ratio of each active matrix drive element to an Al thin film electrode having one side of 226 μm is about 43%. Accordingly, the Al thin film electrode can be further fined.

An anode substrate is fabricated where the active matrix drive element is placed on the inner surface of a vacuum envelope. A fluorescent substance is coated on the surface of each electrode formed on the surface thereof, in the well-known manner.

An active matrix drive IC is disposed in the fluorescent display tube. The active matrix drive IC is formed of a large number of dot-shaped luminous portions in a matrix form corresponding to square Al thin film electrodes arranged in a matrix form at intervals of 20 μm, each having one side of 226 μm. Thus, an active matrix drive fluorescent display tube is fabricated, with the spacing between the filaments above the fluorescent substance layer being 1.5 mm and with the spacing between the filament and the fluorescent substance surface being 1.0 mm. A heat sink is attached on the back surface of the anode substrate in the fluorescent display tube. With a voltage of 20 volts applied to the anode, it was ascertained that the anodes glowed uniformly in display condition.

When the gate of the driver connected to the anode on which a pixel of the active matrix drive element is formed, is OFF, the drain becomes open. The insulating layer formed on the surface of the active drive element accumulates the electrons from the cathode on the surface thereof, so that it has nearly the same potential as the filament. Accordingly, in assumption, when a voltage of 20 volts or more is applied to the anode, to which the lighting signal is supplied, the anode receives sufficient thermal electrons from the filament, so that the uniform display can be obtained.

In the active matrix drive fluorescent display tube of the present invention, since there is no mesh, the mesh deformation and the light shielding by the mesh do not occur. Moreover, since there is no flat grid, the luminous area occupation ratio was increased and the brightness of 40000 cd/m² or more is achieved. Further, since there is no flat grid above the active matrix drive IC, the active matrix drive IC can be miniaturized, so that the cost reduction of the IC can be realized.

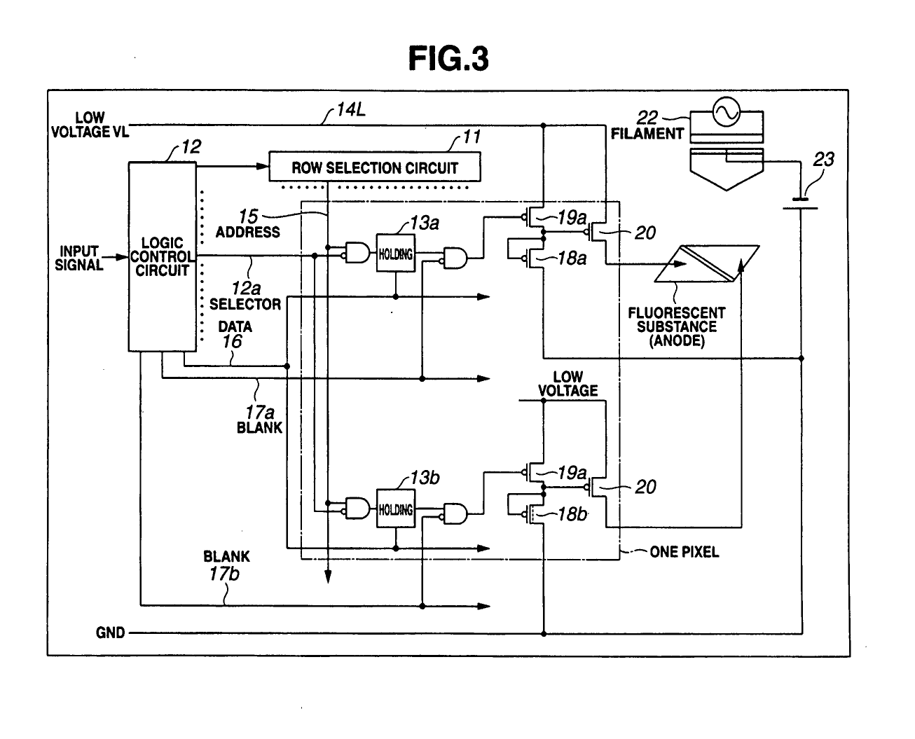

FIG. 3 shows the configuration of a multiple drive circuit.

In the case of the multiple (two-color) drive operation, the data signal line is shared. However, the selector 12a can switch data to pixels divided in color at the same position. The AND circuit, which is connected to the data signal line and to the output signal from the AND circuit engaged with the row signal and the selector, holds data to each of pixels arranged in a matrix form. The subsequent circuit configuration is constructed of P-channel MOS transistors only, in a manner similar to that shown in FIG. 1. The blanking signals are input respectively so as to change over them in a multiple mode, so that the color balance can be adjusted.

An embodiment of the present invention in which the active matrix drive IC is used on the anode substrate of a FED will be explained below.

In the display pixel section, each pixel electrode is formed of a transparent electrode such as ITO. A fluorescent material acting as a luminous layer is coated on the transparent electrode. A cathode substrate, on which Spint-type cold cathode electron emission elements are formed by the well-known manufacturing process, is disposed so as to confront the display pixel section. Thus, a FED is fabricated, with the inside of the housing evacuated in vacuum. The light emission from a fluorescent material is utilized through the transparent electrode and the glass substrate. In this case, the pixel aperture ratio affects the brightness largely. In the present invention, the aperture ratio was improved by 40% to 50%, with the reduced element area. Hence, a high-intensity anode active matrix drive FED can be formed.

An embodiment in the case where an organic EL display is driven will be described below.

In the display pixel section, each pixel electrode is formed of a transparent electrode such as ITO. An organic thin film acting as a luminous layer is formed on the transparent electrode. A cathode is formed on the top layer. The light emission from the organic luminous layer is used through the transparent electrode and the glass substrate. In this case, the pixel aperture ratio largely affects the brightness. In the present invention, the aperture ratio was improved by 40% to 50% with the reduced element area. Thus, a high-intensity organic EL display was fabricated.

An embodiment of the active matrix drive element according to the present invention, shown in FIG. 4, mounted in a fluorescent display tube will be explained below in detail.

In the active matrix drive fluorescent display tube 30 of the embodiment, a silicon wafer or a semiconductor chip, on which plural anodes to be respectively driven are formed in a matrix form, is fixed on the inner surface of the substrate of the envelope. The display tube has an envelope made of an insulating substrate such as glass and a box-shaped container sealed on the substrate. The inside of the envelope is evacuated and maintained in high vacuum atmosphere.

Inside the envelope, a rectangular silicon wafer is fixed securely on the upper surface of the substrate. An insulating layer made of SiN and phosphoric acid glass is formed on the upper surface of the silicon wafer. A large number of dot-shaped luminous portions are formed and arranged in a matrix form and at intervals 20 μm. In the dot-shaped luminous portions, square Al thin film electrodes, each having one side of 226 μm, are connected to drains formed in the insulating layer via through holes, respectively. The rectangular silicon wafer is made of a silicon substrate in a disc-shaped form, obtained by slicing a refined high-purity single crystal silicon cylindrical column. In other words, plural rectangular elements are formed on the disc-shaped silicon wafer. Then, the plural rectangular elements are cut away. In each rectangular element, necessary configurations are fabricated, which includes plural luminous dots in a matrix form, transistors acting as switching elements disposed respectively for respective luminous dots, connection wiring configurations and drivers for driving respective luminous dots in an active matrix mode, drive elements for memories.

Referring to FIG. 4, the rectangular silicon wafer is bonded to the substrate, with a die bond paste. Anode conductors and anodes including fluorescent substance layers, each on which a fluorescent material layer of ZnO:Zn is coated, are arranged in a matrix form on the upper surface of a silicon wafer. A transistor (not shown) acting as a switching element is formed under each anode. Filament-shaped cathodes acting as electron sources are sustained above the silicon wafer inside the envelope. An emissive material is coated around the core wire such as tungsten, which heats through electrical energization. There is, for example, an alkaline-earth metal oxide containing Ba, as an emissive material.

The filament-shaped cathodes are sustained such that the distance between a filament and an anode at the middle of the space between sustained filaments is longer than the distance between filaments. Specifically, the distance between a filament and an anode is 1 mm and the distance between filaments is 1.0 mm. Thus, filaments are sustained such that the distance between a filament and an anode disposed at the middle of the space between filaments is longer than the distance between filaments. As a result, the anode disposed at the middle of the space between filaments sufficiently receives thermal electrons from a filament. Even when an adjacent anode is in a light-out state, sufficient electrons are supplied to it, so that the display becomes uniform.

Next, a process of fabricating the display tube 1 according to the present embodiment will be explained below.
(1) Rectangular elements to be used for the display tube 1 are formed on a sliced circular silicon wafer (having a diameter of 8 inches and a thickness of 0.6 mm). In an example, 17 rectangular elements (the silicon wafer) are fabricated on a single circular silicon wafer.
(2) A fluorescent material slurry containing an ultraviolet photosensitive resin is coated uniformly on the upper surface of the circular silicon wafer.
(3) Using an UV lamp, the upper surface of the circular silicon wafer is exposed to ultraviolet rays via a photomask, which has openings corresponding to luminous dot forms.
(4) A soft fluorescent material slurry is rinsed away using water development.
(5) Acrylic dispersed with acetone is coated and then dried on the upper surface of a circular silicon wafer on which a fluorescent material pattern has been formed, so that an acrylic protective layer is formed. When rectangular elements are cut off from the circular silicon wafer, swarf is washed away with water. The acrylic protective layer prevents the fluorescent material from being peeled off with water. Acrylic, which is decomposed at low temperatures, is removed in the post sintering process.
(6) Rectangular elements (the silicon wafer) are cut out from the circular silicon wafer through dicing, for example, using a diamond cutter.
(7) The cut-out rectangular elements are die-bonded, that is, bonded on the upper surface of the substrate in a display tube with a die bond paste, which Ag and organic Ti are mixed together. Because the die bond paste, which is made of Ag and organic Ti, is easily decomposed, it is not left within the envelope after completion of a product.
(8) In the control IC, the serial to parallel driver for CIG (chip in glass) is bonded on the upper surface of the same substrate with die bond paste.
(9) The resin in the fluorescent material layer, the acrylic resin coating the fluorescent material, and the die bond paste, used in the above-mentioned steps, are removed through thermal decomposition. The alumina sol is sintered and solidified, thus being converted into an insulating cover film.
(10) A wire bonding process is performed. That is, the electrodes, which are formed on the upper surfaces of rectangular elements and the substrate, and electrodes, which are formed on the upper surfaces of rectangular elements and the substrate, are respectively connected with wire.
(11) Then, face to face bonding is performed. That is, the completed lead frame is placed at a predetermined position on the substrate. The intermediate structure is placed over the completed envelope and is temporarily fixed with fixing means (such as a clip).
(12) The intermediate structure is sintered and sealed at about 450° C. Thus, the seal glass between the envelope and the substrate fuses to fix the envelope and the lead frame and the substrate.
(13) Then, the inside of the envelope is evacuated. When the envelope is at a predetermined high vacuum atmosphere, the exhaust tube is sealed. When a getter is sputtered, a getter film is formed over the inner surface of the envelope.
(14) The structure is sintered at 160° C. to 300° C. in an oven so that the getter film absorbs the residual gas.
(15) The display tube is subjected to aging.

In the drive operation of the display tube fabricated as described above, a switching transistor selects a desired anode on a silicon wafer displaced in an envelope and electrons emitted from the cathode impinge to the fluorescent substance layer corresponding to the selected anode. When desired anodes in the matrix are selectively light-emitted, an arbitrary graphic display is manifested.

With a heat sink attached to the back surface of the anode substrate in the fluorescent display tube, a voltage of 60 volts was applied to an anode to ascertain the state of display. The fluorescent material was light emitted uniformly so that the display was obtained at a luminous intensity of 40000 cd/m².

Because the mesh grid is not used, deformation of the mesh does not occur. Moreover, because the mesh does not shield light, a luminous intensity of 40000 cd/m² is obtained.

Because the flat grid is not disposed above the active matrix drive IC, the active matrix drive IC can be miniaturized. The cost of IC can be reduced.

With a heat sink attached to the back surface of the anode substrate in the fluorescent display tube, a voltage of 15 volts was applied to an anode to ascertain the state of display, so that a luminous intensity of 4000 cd/m² was obtained. The brightness of the peripheral area around the anode between filaments was lowered. However, with the anode applied a voltage of 20 volts, it was observed that the anode glows uniformly.

When the anode, to which a voltage of 20 volts or more is applied, receives sufficient thermal electrons from the filament, the potential of the active matrix substrate becomes the same potential as that of the filament. For that reason, it is assumed that even when the adjacent anode does not glow, sufficient electrons are supplied, so that the display becomes uniform.

In the multiple (two-color) drive operation shown in FIG. 3, a fluorescent material layer of ZnO:Zn emitting cyan color is formed for one pixel connected to the drain of the driver of the active matrix drive IC. A fluorescent material layer of ZnCdS:Ag,Cl emitting reddish-orange color is formed for the other pixel. Thus, an active matrix drive display tube is fabricated in a manner similar to that in the embodiment 1. With a voltage of 15 volts applied to the anode, it was observed that ZnO:Zn fluorescent material emitting cyan color glows at 4000 cd/m² uniformly and the ZnCd:Ag,Cl fluorescent material emitting reddish-orange color glows 400 cd/m² uniformly. A full-color (three-color) display can be easily fabricated by adding a blue fluorescent material to the anode.

An embodiment using polysilicon Si will be explained below.

In this embodiment, a brosilicate glass (to be described later), acting as a base body of an anode substrate, is used for the glass member constructing a vacuum envelope.

The anode substrate is an active matrix substrate on which a luminous display section and a drive circuit for controlling the luminous display section are integrally formed. The anode substrate has a polysilicon film formed over the surface of a glass substrate acting as a base body. A semiconductor integrated circuit, including thin film transistors (TFTs), is formed in the polysilicon film. The semiconductor circuit configures a drive circuit. The thin film transistor formed in the polysilicon film has characteristics two to three digits higher than the thin film transistor formed in an amorphous silicon film. Particularly, the display area can be enlarged effectively.

A low temperature polysilicon film, which is processed at a temperature less than a distortion point of a glass substrate, can be used for the polysilicon film. The low temperature polysilicon film is usually formed at 450° C. to 600° C. is according to the well known technique such as, for example, the chemical vapor deposition (CVD) process. A brosilicate glass, which does not contain sodium, which adversely affects transistor characteristics, is used as the glass substrate. The semiconductor integrated circuit formed in polysilicon film is fabricated by the well-known fabrication process, which uses low temperature polysilicon films.

The surface of the polysilicon film is covered with a passivation film (an insulating film) and a luminous display section is formed on the passivation film. The luminous display section includes anode electrodes arranged on the passivation film in a matrix form and at a predetermined pitch, dot-shaped fluorescent materials, coated on each of the anode electrodes, and auxiliary electrodes, arranged on the passivation film to surround each of the anode electrodes.

A thin-film transistor formed portion of the anode drive portion acting as part of a drive circuit is formed beneath each anode electrode. The thin-film transistor formed portion is connected to anode electrodes via through holes formed in the passivation film. The anode electrodes and the bonding pads are formed of aluminum. The fluorescent material is formed of the fluorescent material used in the conventional display device. The passivation films, the anode electrodes, the fluorescent substance, and the bonding pads can be formed according to the conventional method.

In this fluorescent display device, thermal electrons emitted from an electrically heated filament are radiated from an anode substrate. The radiated electrodes enter anodes, each to which a positive voltage is applied, in an active matrix drive operation to light emit the fluorescent material. Thus the image for input data is displayed.

The active drive fluorescent display tube, which has the pixel pitch of 250 μm or less and a pixel interval of 20 μm or less, can be provided. With a heat sink attached to the back surface of the anode substrate, a voltage of 60 volts is applied to an anode. In such a state, it was observed that a high intensity active matrix drive fluorescent display tube can be obtained, in which the fluorescent material glows uniformly and the pixels glow uniformly at 40000 cd/m². The brightness can be improved four times about 10000 cd/m² realized by the conventional high-intensity active matrix drive fluorescent display tube. A high-intensity dot matrix head-up display can be put in practical use by using the high-intensity active matrix drive fluorescent display tube. Further, according to the present invention, a high-intensity multiple color active matrix drive fluorescent display tube can be provided. Furthermore, anode substrates for organic ELDs in high-intensity micro-pattern and for FEDs in high-intensity micro-pattern can be provided by means of employing the active matrix drive IC configuration of the present invention.

The invention has been described in connection with what are presently considered to be the most practical and preferred embodiments. However, the present invention has been presented by way of illustration and is not intended to be limited to the disclosed embodiments. Accordingly, those skills in the art will realize that the invention is intended to encompass all modifications and alternative arrangements included within the sprit and scope of the invention, as set forth by the appended claims.

What is claimed is:

1. An active matrix drive display element including a pixel driver; said pixel driver comprising:
a logic circuit formed of a row address selection circuit and a logic control circuit;
a holding unit disposed for each pixel;
an AND circuit for performing logical product on a signal held in said holding unit and a blanking reverse signal from an input data signal line;
a pre-driver circuit formed of an enhancement-mode P-channel field-effect transistor and a depletion-mode P-channel field-effect transistor; and
an output driver circuit connected to said pre-driver circuit.

2. An active matrix drive display element including a pixel driver; said pixel driver comprising:
a logic circuit formed of a row address selection circuit and a logic control circuit;
a holding unit disposed for each pixel;
an AND circuit for performing logical product on a signal held in said holding unit and a blanking reverse signal from an input data signal line;
a pre-driver circuit formed of an enhancement-mode P-channel field-effect transistor and a high resistance element; and
an output driver circuit connected to said pre-driver circuit.

3. The active matrix drive display element as defined in claim 1, wherein said driver output circuit disposed for each of said plural pixels is composed of a high withstand voltage transistor; and wherein said holding unit for driving anode electrodes and said pre-driver circuit for driving an output transistor in an previous stage are composed of a low withstand voltage transistor.

4. The active matrix drive display element as defined in claim 2, wherein said driver output circuit disposed for each of said plural pixels is composed of a high withstand voltage transistor; and wherein said holding unit for driving anode electrodes and said pre-driver circuit for driving an output transistor in an previous stage are composed of a low withstand voltage transistor.

5. The active matrix drive display element as defined in claim 1, further comprising a pixel electrode which light-emits a luminous material in a pixel connected to a drain electrode of said output driver circuit; and wherein a pixel drive unit is formed of P-channel MOS field-effect transistors, said pixel drive unit consisting of said holding unit for driving an anode electrode disposed for each of said pixels, said AND circuit for performing logical product on a signal held in said holding unit and a blanking reverse signal from an input data signal line, said pre-driver circuit for driving an output transistor in a previous stage, and said driver output circuit connected to said pre-driver circuit.

6. The active matrix drive display element as defined in claim 2, further comprising a pixel electrode which light-emits a luminous material in a pixel connected to a drain electrode of said output driver circuit; and wherein a pixel drive unit is formed of P-channel MOS field-effect transistors, said pixel drive unit consisting of said holding unit for driving an anode electrode disposed for each of said pixels, said AND circuit for performing logical product on a signal held in said holding unit and a blanking reverse signal from an input data signal line, said pre-driver circuit for driving an output transistor in a previous stage, and said driver output circuit connected to said pre-driver circuit.

7. The active matrix drive display element as defined in claim 5, wherein said P-channel MOS field-effect transistor comprises a P-channel MOS field-effect transistor having an I layer made of a Si oxide.

8. The active matrix drive display element as defined in claim 6, wherein said P-channel MOS field-effect transistor comprises a P-channel MOS field-effect transistor having an I layer made of a Si oxide.

9. An active matrix drive display element comprising:
a logic circuit formed of a row address for each display pixel and a logic control circuit;
a holding unit and a driver circuit, for driving an anode electrode disposed for each display pixel; and
a driver output circuit in a display pixel unit;
wherein an input signal is formed of a row address selection signal, a logic control signal, and display data; and a decoder selects a row address signal for one row only; and display data is input for each column; and display data for pixels arranged in a matrix form by an AND circuit, which performs logical product on said row address signal and said data signal line, correspond to data for one row; and said row address signal is sequentially incremented repeatedly until data are written for all rows;
wherein said AND circuit, which performs logical product on holding data and a blanking signal, outputs data as display data to the driver circuit in the final stage via said driver circuit.

10. The active matrix drive display device, as defined in claim 1, wherein data signal line is shared in use; and a selector switches said data signal; and an AND circuit, which is engaged to a row address signal, a signal output from an AND circuit in said selector, and a data signal line, holds data for each of pixels arranged in a matrix form, each pixel being divided in color at the same portion; and wherein blanking signals are input separately to change every multiple mode.

11. The active matrix drive display device, as defined in claim 2, wherein data signal line is shared in use; and a selector switches said data signal; and an AND circuit, which is engaged to a row address signal, a signal output from an AND circuit in said selector, and a data signal line, holds data for each of pixels arranged in a matrix form, each pixel being divided in color at the same portion; and wherein blanking signals are input separately to change every multiple mode.

12. The active matrix drive display device, as defined in claim 9, wherein data signal line is shared in use; and a selector switches said data signal; and an AND circuit, which is engaged to a row address signal, a signal output from an AND circuit in said selector, and a data signal line, holds data for each of pixels arranged in a matrix form, each pixel being divided in color at the same portion; and wherein blanking signals are input separately to change every multiple mode.

13. The active matrix drive display element as defined in claim 1, wherein a circuit following the holding circuit of an AND circuit, which performs logical product on a data signal line and a row-selected signal line, is disposed for each cell; and wherein said circuit is arranged beneath each pixel.

14. The active matrix drive display element as defined in claim 2, wherein a circuit following the holding circuit of an AND circuit, which performs logical product on a data signal line and a row-selected signal line, is disposed for each cell; and wherein said circuit is arranged beneath each pixel.

15. The active matrix drive display element as defined in claim 9, wherein a circuit following the holding circuit of an AND circuit, which performs logical product on a data signal line and a row-selected signal line, is disposed for each cell; and wherein said circuit is arranged beneath each pixel.

16. The active matrix drive display element as defined in claim 1, wherein said driver circuit is formed of field-effect transistors fabricated on a Si wafer.

17. The active matrix drive display element as defined in claim 2, wherein said driver circuit is formed of field-effect transistors fabricated on a Si wafer.

18. The active matrix drive display element as defined in claim 9, wherein said driver circuit is formed of field-effect transistors fabricated on a Si wafer.

19. The active matrix drive display element as defined in claim 1, wherein said driver circuit is formed of field-effect transistors, each which is made of amorphous Si.

20. The active matrix drive display element as defined in claim 2, wherein said driver circuit is formed of field-effect transistors, each which is made of amorphous Si.

21. The active matrix drive display element as defined in claim 9, wherein said driver circuit is formed of field-effect transistors, each which is made of amorphous Si.

22. A fluorescent display device including an active matrix drive display element as defined in claim 1, wherein said drive circuit and an integrated circuit for driving said drive circuit are mounted in a vacuum envelope, and wherein pixels are formed of anodes being drain electrodes, each on which a fluorescent substance is coated.

23. A fluorescent display device including an active matrix drive display element as defined in claim 2, wherein said drive circuit and an integrated circuit for driving said drive circuit are mounted in a vacuum envelope, and wherein pixels are formed of anodes being drain electrodes, each on which a fluorescent substance is coated.

24. A fluorescent display device including an active matrix drive display element as defined in claim 9, wherein said drive circuit and an integrated circuit for driving said drive circuit are mounted in a vacuum envelope, and wherein pixels are formed of anodes being drain electrodes, each on which a fluorescent substance is coated.

25. A fluorescent display device as defined in claim 22, wherein the spacing between filaments, is 1.5 times or less the spacing between a filament and an anode.

26. A fluorescent display device as defined in claim 23, wherein the spacing between filaments, is 1.5 times or less the spacing between a filament and an anode.

27. A fluorescent display device as defined in claim 24, wherein the spacing between filaments, is 1.5 times or less the spacing between a filament and an anode.

28. An active matrix drive fluorescent display device as defined in claim 22 wherein the spacing between filaments is 1.5 mm or less.

29. An active matrix drive fluorescent display device as defined in claim 23 wherein the spacing between filaments is 1.5 mm or less.

30. An active matrix drive fluorescent display device as defined in claim 24 wherein the spacing between filaments is 1.5 mm or less.
